(19) United States
(12) Patent Application Publication
(10) Pub. No.: US 2015/0169926 A1
(43) Pub. Date: Jun. 18, 2015

(54) READER FOR BARCODE AND PACKAGE PROCESSING SYSTEM USING SAME

(71) Applicants: Fu Tai Hua Industry Shenzhen) Co., Ltd., Shenzhen (CN); HON HAI PRECISION INDUSTRY CO., LTD., New Taipei (TW)

(72) Inventors: ZONG-YUAN SUN, New Taipei (TW); DA-HUA XIAO, Shenzhen (CN)

(21) Appl. No.: 14/520,007

(22) Filed: Oct. 21, 2014

(30) Foreign Application Priority Data
Dec. 12, 2013 (CN) 201310672832.3

(51) Int. Cl. G06K 7/10

(52) U.S. Cl. CPC G06K 7/10881

(57) ABSTRACT

A reader includes a main body, a pen, and a control unit. The pen is located at a first end of the main body. The control unit is received in a second end of the main body and includes a barcode scanning module, a microcontroller, and a near field communication (NFC) module. The barcode scanning module scans barcodes to obtain barcode information of the barcodes. The microcontroller is electronically connected to the barcode scanning module and decodes the barcode information. The NFC module is electronically connected to the microcontroller and sends the decoded barcode information from the microcontroller to a portable electronic device.

### CROSS-REFERENCE TO RELATED APPLICATIONS

This application claims priority to Chinese Patent Application No. 201310672832.3 filed on Dec. 12, 2013, the contents of which are incorporated by reference herein.

### FIELD

The disclosure generally relates to a barcode reader and a package processing system using the barcode reader.

### BACKGROUND

Readers for barcodes are common in businesses. The reader may scan the barcodes to obtain a package serial number. Additionally, related package information (for example, destination or telephone numbers) can be edited through the reader, and then the package serial number and the related package information are sent to a terminal server located at a package company.

### BRIEF DESCRIPTION OF THE DRAWINGS

Implementations of the present technology will now be described, by way of example only, with reference to the attached figures.

FIG. 1 is an assembled, isometric view of an embodiment of a reader including a main body, a control unit, and a pen.

FIG. 2 is an exploded, isometric view of the main body and the control unit of the reader shown in FIG. 1.

FIG. 3 is an exploded, isometric view of the pen of the reader shown in FIG. 1.

FIG. 4 is a block diagram of an embodiment of a package processing system including the reader of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

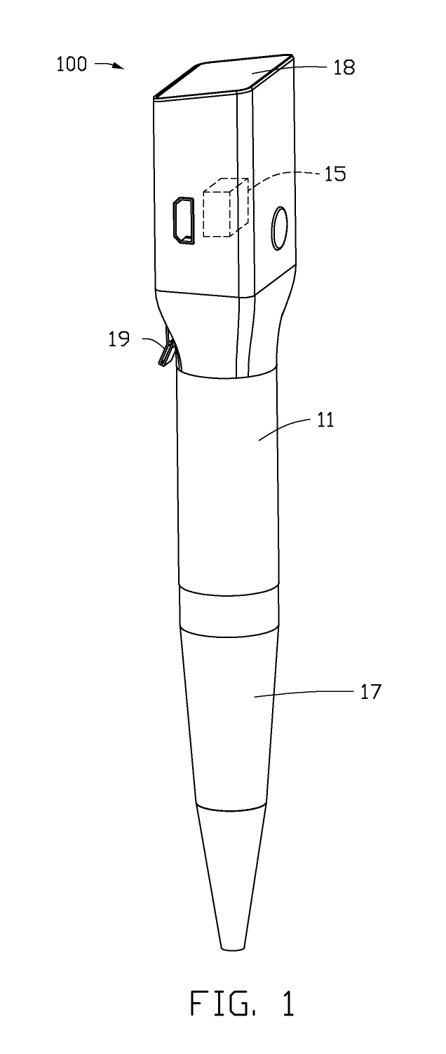

FIG. 1 illustrates an embodiment of a reader 100. The reader 100 may be used in a package business and is configured to scan barcodes on a package bill to obtain information, such as a package serial number. In this embodiment, the reader 100 is substantially pen-shaped and includes a main body 11, a control unit 15, and a pen 17.

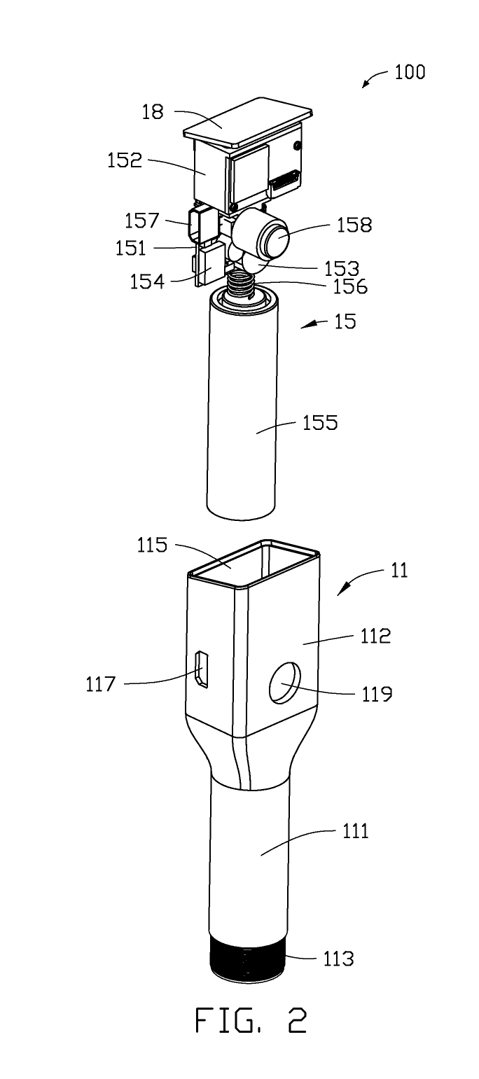

FIG. 2 illustrates that the main body 11 includes a base 111 and a receiving portion 112. The base 111 is a substantially cylinder. One end of the base 111 includes a threaded portion 113. The receiving portion 112 is substantially rectangular and is positioned at an end of the base 111 away from the threaded portion 113. An end of the receiving portion 112 away from the base 111 defines a receiving space 115. In this embodiment, the receiving space 115 is substantially rectangular and is configured for receiving the control unit 15. A peripheral wall of the receiving space 115 defines a first hole 117 and a second hole 119. The first hole 117 and the second hole 119 are both coupled to the receiving space 115 by a channel.

The control unit 15 is received in the receiving space 115. The control unit 15 includes a circuit board 151, a barcode scanning module 152, a microcontroller 153, a near field communication (NFC) module 154, a power source 155, an elastic member 156, a power port 157, and a button 158. The barcode scanning module 152, the microcontroller 153, and the NFC module 154 are all located on and electronically connected to the circuit board 151. The barcode scanning module 152 may be an infrared photoelectric sensor and is configured to scan the barcodes on the package bill to obtain barcode information. The microcontroller 153 is electronically connected between the barcode scanning module 152 and the NFC module 154. The microcontroller 153 decodes the barcode information from the barcode scanning module 152 into a package serial number, and transmits the package serial number to the NFC module 154. In other embodiments, the NFC module 154 may be replaced by a Bluetooth (BT) module, a wireless fidelity (WIFI) module, or other near field modules.

The power source 155 may be a battery and is positioned below the circuit board 151. In this embodiment, the elastic member 156 is a spring. A first end of the elastic member 156 is fixed to the circuit board 151. A second end of the elastic member 156 is coupled to the power source 155. Then, the power source 155 is electronically connected to the circuit board 151 through the elastic member 156 and provides power to the circuit board 151, the barcode scanning module 152, the microcontroller 153, and the NFC module 154.

The power port 157 is positioned at a side of the circuit board 151 and is partially exposed from the first hole 117. Then, the power port 157 may be electronically connected to an outside charging device to charge the reader 100. The button 158 is positioned on the circuit board 151 and is partially exposed from the second hole 119. When the button 158 is actuated, the control unit 15 enters into a working state or an idle state.

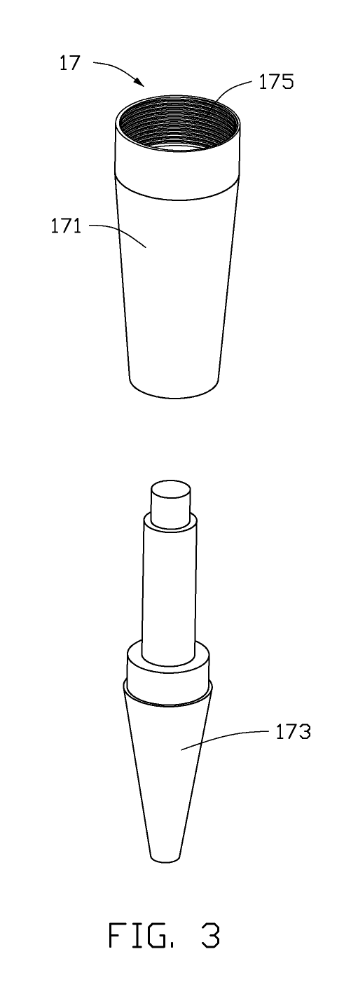

FIG. 3 illustrates that the pen 17 includes a pen body 171 and a pen head 173. In this embodiment, the pen body 171 is a substantially hollow cylinder. One end of the pen body 171 defines a threaded hole 175. The threaded portion 113 of the base 111 can be engaged with the threaded hole 175 of the pen body 171, then the pen body 171 can be assembled at one end of the base 111 away from the receiving portion 112. That is, the pen body 171 and the receiving portion 112 are located at two opposite ends of the base 111. The pen head 173 is partially received in an end of the pen body 171 away from the threaded hole 175.

In other embodiments, the reader 100 further includes a protecting member 18 and a clamping member 19. In this embodiment, the protecting member 18 is a substantially rectangular board and may be made of a transparent acrylic material. The protecting member 18 is positioned above the receiving space 115 to cover the control unit 15, thereby protecting the barcode scanning module 152. The clamping member 19 is positioned at a side of the receiving portion 112 and can be clamped at an article, for example, clothes of a user, thus the reader 100 is entirely portable.

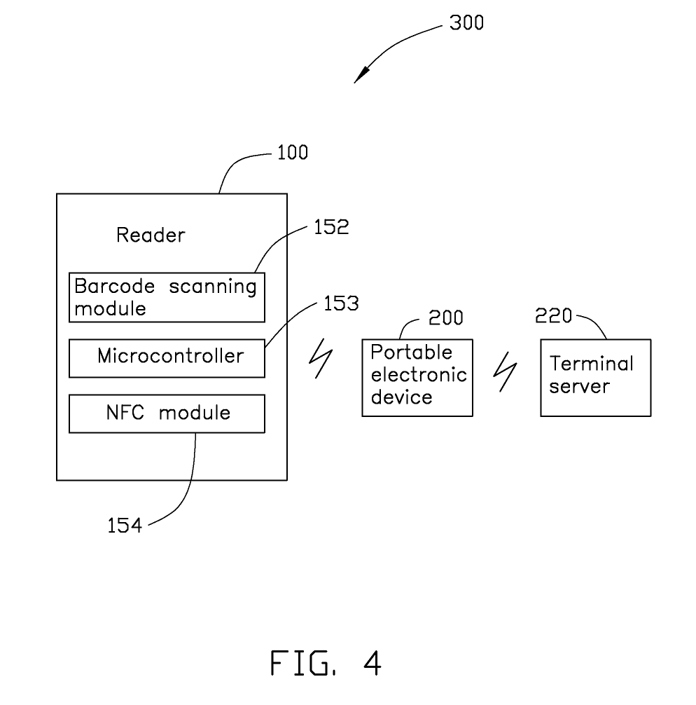

Referring to FIG. 4, the reader 100 communicates with a portable electronic device 200, such as a mobile phone, for example. The portable electronic device 200 is further in communication with a terminal server 220 located at a package company. The reader 100, the portable electronic device 200, and the terminal server 220 cooperatively form a package processing system 300.

At least one program or other software is installed in the portable electronic device 200 in relation to the package business, to edit related package information (for example, destinations or telephone numbers). Both the package serial number received from the reader 100 and the related package information are sent to the terminal server 220 via a wireless communication network, such as 2G/3G network, for example.

In use, the button 158 is actuated to activate the control unit 15. The barcode scanning module 152 scans the barcodes on the package bill to obtain barcode information. The microcontroller 153 decodes the barcode information, obtains the package serial number, and transmits the package serial number to the NFC module 154. The NFC module 154 communicates with the portable electronic device 200 and sends the package serial number to the portable electronic device 200. The button 158 can be actuated again to deactivate the control unit 15.

The related package information including destination or telephone numbers is written by hand on the package bill via the pen head 173 of the pen 17, or the related package information is directly edited on the portable electronic device 200, so that the related package information and the package serial number received from the reader 100 can be sent to the terminal server 220.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A reader comprising:
a main body;
a pen located at a first end of the main body; and
a control unit received in a second end of the main body, the control unit comprising:
a barcode scanning module configured to scan barcodes to obtain barcode information of the barcodes;
a microcontroller electronically connected to the barcode scanning module and configured to decode the barcode information; and
a near field communication (NFC) module electronically connected to the microcontroller and configured to send the decoded barcode information from the microcontroller to a portable electronic device.

2. The reader of claim 1, wherein the main body comprises a base and a receiving portion, the pen is located at one end of the base, the receiving portion is positioned at the other end of the base away from the pen and defines a receiving space, the control unit is received in the receiving space.

3. The reader of claim 2, wherein the pen comprises a pen body and a pen head, one end of the pen body defines a threaded hole, the one end of the base comprises a threaded portion, the threaded portion of the base is engaged with the threaded hole of the pen body to assembled the pen body to the base, the pen head is partially received in an end of the pen body away from the threaded hole.

4. The reader of claim 1, wherein the control unit further comprises a circuit board and a power source, the barcode scanning module, the microcontroller, and the NFC module are all located on and electronically connected to the circuit board, the power source is electronically connected to the circuit board and provides power to the circuit board, the barcode scanning module, the microcontroller, and the NFC module.

5. The reader of claim 4, wherein the control unit further comprises an elastic member, a first end of the elastic member is fixed to the circuit board, and a second end of the elastic member is coupled to the power source.

6. The reader of claim 2, wherein a peripheral wall of the receiving space defines a first hole, the control unit further comprises a power port, the power port is positioned on the circuit board and partially exposed from the first hole for electronically connected to an outside charging device to charge the reader.

7. The reader of claim 6, wherein the peripheral wall of the receiving space further defines a second hole, the control unit further comprises a button, the button is positioned on the circuit board and is partially exposed from the second hole, the control unit is activated and deactivated by manipulation of the button.

8. The reader of claim 2, further comprising a protecting member, wherein the protecting member is positioned above the receiving space to cover the control unit.

9. The reader of claim 2, further comprising a clamping member, wherein the clamping member is positioned at a side of the receiving portion.

10. The reader of claim 1, wherein the NFC module is one of a bluetooth (BT) module and a wireless fidelity (WIFI) module.

11. A package processing system comprising:
a portable electronic device; and
a reader in communication with the portable electronic device, the reader comprising:
a main body;
a pen located at a first end of the main body; and
a control unit received in a second end of the main body, the control unit comprising:
a barcode scanning module scanning barcodes to obtain barcode information of the barcodes;
a microcontroller electronically connected to the barcode scanning module and decoding the barcode information; and
a near field communication (NFC) module electronically connected to the microcontroller and sending the decoded barcode information from the microcontroller to the portable electronic device.

12. The package processing system of claim 11, wherein the main body comprises a base and a receiving portion, the pen is located at one end of the base, the receiving portion is positioned at the other end of the base away from the pen and defines a receiving space, the control unit is received in the receiving space.

13. The package processing system of claim 12, wherein the pen comprises a pen body and a pen head, one end of the pen body defines a threaded hole, the one end of the base comprises a threaded portion, the threaded portion of the base is engaged with the threaded hole of the pen body to assembled the pen body to the base, the pen head is partially received in an end of the pen body away from the threaded hole.

14. The package processing system of claim 11, wherein the control unit further comprises a circuit board and a power source, the barcode scanning module, the microcontroller, and the NFC module are all located on and electronically connected to the circuit board, the power source is electronically connected to the circuit board and provides power to the circuit board, the barcode scanning module, the microcontroller, and the NFC module.

15. The package processing system of claim 14, wherein the control unit further comprises an elastic member, a first end of the elastic member is fixed to the circuit board, and a second end of the elastic member is coupled to the power source.

16. The package processing system of claim 12, wherein a peripheral wall of the receiving space defines a first hole, the control unit further comprises a power port, the power port is positioned on the circuit board and exposed from the first hole for electronically connected to an outside charging device to charge the reader.

17. The package processing system of claim 16, wherein the peripheral wall of the receiving space further defines a second hole, the control unit further comprises a button, the button is positioned on the circuit board and is partially exposed from the second hole, the control unit is activated and deactivated by manipulation of the button.

18. The package processing system of claim 12, further comprising a protecting member, wherein the protecting member is positioned above the receiving space to cover the control unit.

19. The package processing system of claim 12, further comprising a clamping member, wherein the clamping member is positioned at a side of the receiving portion.

20. The package processing system of claim 11, wherein the NFC module is one of a BT module and a WIFI module.
